(19) United States
(12) Patent Application Publication
(10) Pub. No.: US 2015/0138979 A1
(43) Pub. Date: May 21, 2015

(54) NETWORK MANAGEMENT CONTROL DEVICE, NETWORK MANAGEMENT CONTROL SYSTEM, AND NETWORK MANAGEMENT CONTROL METHOD

(71) Applicant: HITACHI, LTD., Tokyo (JP)

(72) Inventors: Tomoyuki IIJIMA, Tokyo (JP); Toshiaki SUZUKI, Tokyo (JP); Hidenori INOUCHI, Tokyo (JP)

(73) Assignee: HITACHI, LTD., Tokyo (JP)

(21) Appl. No.: 14/546,314

(22) Filed: Nov. 18, 2014

(30) Foreign Application Priority Data
Nov. 21, 2013 (JP) 2013-241048

(51) Int. Cl. H04L 12/741; H04L 12/723; H04L 12/801

(52) U.S. Cl. CPC H04L 45/74; H04L 47/12; H04L 45/50
USPC 370/235; 370/392

(57) ABSTRACT

A network is optimized quickly and flexibly according to a request from a user who conducts data communication, or a trend of the traffic. Plural packet transport devices have plural paths between the respective devices, and packets transmitted from plural packet transfer devices can be transferred on the path. A management control device calculates a path most suitable for transmitting the packet, identifies an identifier necessary for transferring the packet on the path, and sets the packet transfer devices so as to allocate the identifier to the packet from the user, and transport the packet to the packet transport devices.

### CLAIM OF PRIORITY

The present application claims priority from Japanese patent application JP 2013-241048 filed on Nov. 21, 2013, the content of which is hereby incorporated by reference into this application.

### BACKGROUND OF THE INVENTION

1. Field of the Invention

The present invention relates to a network management control device, a network management control system, and a network management control method, and particularly to a network management control device, a network management control system, and a network management control method, which manage plural packet transport network devices.

2. Description of the Background Art

Research and development of a Software Defined Networking (SDN) product has been activated. The SDN is a concept that separates a control function and a communication function of a network into a network management control device and managed control devices, optimizes an overall communication function of the plural managed control devices by one network management control device, and then controls the managed control devices.

As SDN products, open flow switches are frequently mentioned, but the SDN products are not limited to this configuration. Objects to be controlled can include not only a communication function but also a virtualization function and a power saving function. For example, a typical example of packet transport devices includes a multi-protocol label switching transport profile (MPLS-TP) device, and architecture is a model that controls plural packet transport devices by one management control device as with the open flow switches. An overall optimization of the communication function, the virtualization function, and the power saving function, or the optimization of those plural functions, which are expected to be realized by the SDN, can be realized by a network built by the MPLS-TP device.

### CITATION LIST

Patent Literature 1: JP-A-2013-9438

### SUMMARY OF THE INVENTION

The MPLS-TP device establishes a label switched path (LSP) or a pseudo wire as a communication path, and transports packets on the communication path. Those communication paths have an advantage that a high reliability or a high fault tolerance equivalent to a transport technique such as synchronous data hierarchy (SDH) can be allocated, but have a disadvantage that establishment cannot be always instantly performed.

The present invention has been made in view of the above drawbacks, and an objective of the present invention is to provide a network management control device, a network management control system, and a network management control method, which optimize a network built by the MPLS-TP device flexibly and quickly according to a demand from a user that performs data communication, and a trend of traffic.

According to the first solving means of the present invention, it is provided a network management control device in a network management control system including plural packet transfer devices and plural packet transport devices, and having plural paths between the packet transport devices in which each of the packet transfer devices transmits a packet including an identifier necessary for transferring to the paths, and each of the packet transport devices transfers the packet to the paths according to the identifier,

wherein the network management control device manages the plurality of packet transfer devices and the plurality of packet transport devices,

the network management control device identifies a path that guarantees a bandwidth for transmitting the packet, and the identifier for the path, on the basis of a request including a bandwidth from a user who transmits the packet, and

the network management control device sets the packet transfer devices so as to allocate the identifier to the packet from the user and transmit the packet to the packet transport device.

According to the second solving means of the present invention, it is provided a network management control system including:

plural packet transfer devices;

plural packet transport devices; and

a network management control device,

wherein the network management control system has plural paths between the packet transport devices, each of the packet transfer devices transmits a packet including an identifier necessary for transferring to the paths, and each of the packet transport devices transfers the packet to the paths according to the identifier, and

wherein the network management control device manages the plurality of packet transfer devices and the plurality of packet transport devices,

the network management control device identifies a path that guarantees a bandwidth for transmitting the packet, and the identifier for the path, on the basis of a request including a bandwidth from a user who transmits the packet, and

the network management control device sets the packet transfer devices so as to allocate the identifier to the packet from the user and transmit the packet to the packet transport device.

According to the third solving means of the present invention, it is provided a network management control method in a network management control system including plural packet transfer devices and plural packet transport devices, and having plural paths between the packet transport devices in which each of the packet transfer devices transmits a packet including an identifier necessary for transferring to the paths, and each of the packet transport devices transfers the packet to the paths according to the identifier, the network management control method including:

managing the plurality of packet transfer devices and the plurality of packet transport devices,

identifying a path that guarantees a bandwidth for transmitting the packet, and the identifier for the path, on the basis of a request including a bandwidth from a user who transmits the packet, and

setting the packet transfer devices so as to allocate the identifier to the packet from the user and transmit the packet to the packet transport device.

It is possible, according to the present invention, to provide a network management control device, a network management control system, and a network management control method, which optimize a network built by the MPLS-TP device flexibly and quickly according to a demand from a user that performs data communication, and a trend of traffic.

### BRIEF DESCRIPTION OF THE DRAWINGS

FIG. 1 is a block diagram illustrating a configuration of a network having a network management control device, plural packet transfer devices, and plural packet transport devices;

FIG. 2 is a block diagram illustrating a configuration of the packet transfer devices according to an embodiment;

FIG. 3 is a block diagram illustrating a configuration of the packet transport devices according to the embodiment;

FIG. 4 is a block diagram illustrating a configuration of the network management control device according to the embodiment;

FIG. 5 is a diagram illustrating an example of configuration information within the packet transfer devices according to the embodiment;

FIG. 6 is a diagram illustrating an example of state information within the packet transfer devices according to the embodiment;

FIG. 7 is a diagram illustrating an example of setting information within the packet transport devices according to the embodiment;

FIG. 8 is a diagram illustrating an example of the packet transfer device/packet transport device compatible table within the network management control device according to the embodiment;

FIG. 9 is a diagram illustrating an example of a resource pool within the network management control device according to the embodiment;

FIG. 10 is a diagram illustrating an example of a resource pool management unit within the network management control device according to the embodiment;

FIG. 11 is a sequence diagram illustrating a flow in which the network management control device controls the packet transfer devices, and uses a network built in the packet transport devices with high efficiency according to the embodiment;

FIG. 12 is a flowchart illustrating a flow in which the network management control device controls the packet transfer devices, and uses a network built in the packet transport devices with high efficiency according to the embodiment;

FIG. 13 is a diagram illustrating a configuration example of the resource pool within the network management control device according to the embodiment.

### DETAILED DESCRIPTION OF THE INVENTION

Hereinafter, an embodiment of the present invention will be described with reference to the accompanying drawings.

### First Embodiment

### (A1) Network Configuration

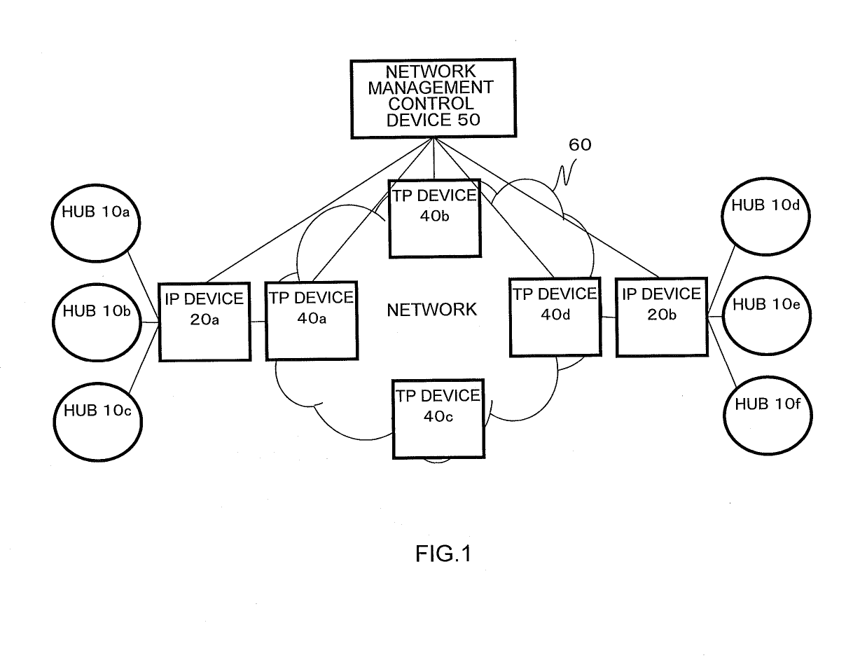

FIG. 1 is a block diagram illustrating a configuration of a network having a network management control device, plural packet transfer devices (hereinafter referred to as “IP devices”), and plural packet transport devices (hereinafter referred to as “TP devices”). In the figure, six hubs 10a to 10f are present, and data transmitted from those hubs 10a to 10f is accommodated in an IP device 20a or 20b. The data transferred by the IP devices 20 is accommodated in a TP device 40a or 40d, and transferred to the TP device closest to a destination hub through an LSP or a pseudo wire. The plural IP devices 20 and the plural TP devices 40 are managed by a network management control device 50 through a network 60.

A configuration of the network, the number of IP devices 20, and the number of TP devices 40 are not limited to an example illustrated in FIG. 1, and can be appropriately changed to other configurations.

### (A2) Configuration of Packet Transfer Devices

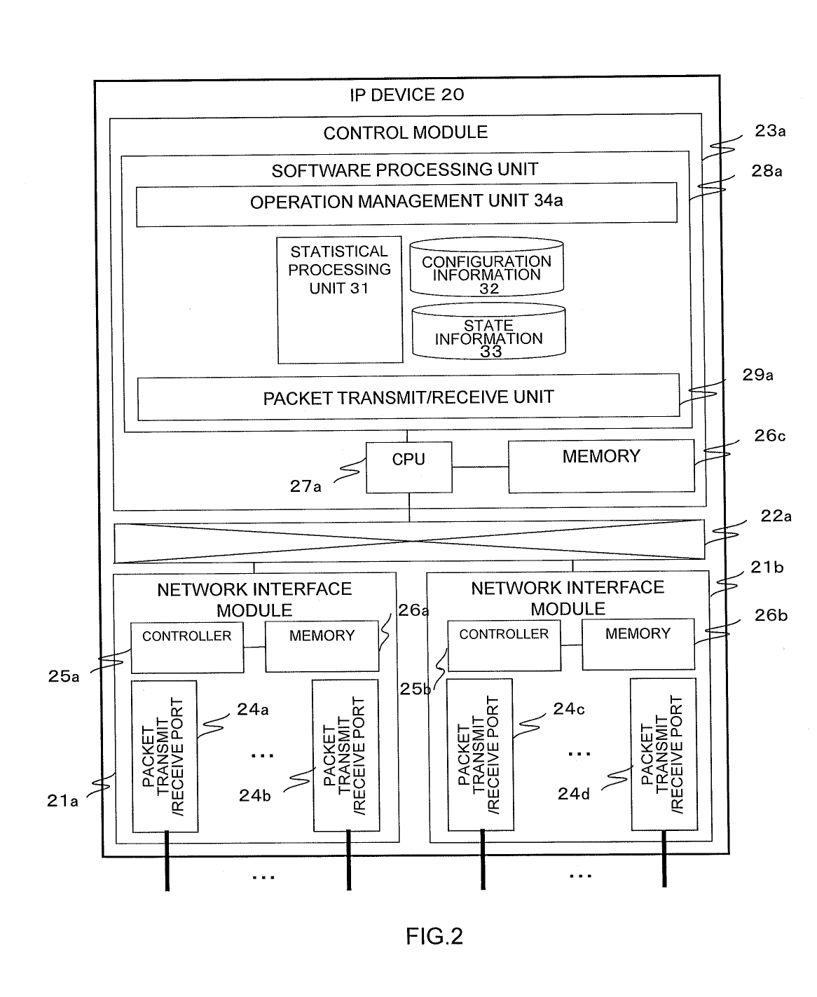

FIG. 2 is a block diagram illustrating a schematic configuration of the packet transfer devices (hereinafter referred to as “IP devices”) 20. Each of the IP devices 20 includes plural network interface modules 21a, 21b, a switching module 22a, and a control module 23a.

The network interface modules 21 include plural packet transmit/receive ports 24a to 24d, controllers 25a, 25b, and memories 26a, 26b. The packet transmit/receive ports 24a to 24d are physically connected with an Ethernet (registered trademark) cable. The controller 25 of each network interface module 21 analyzes a packet received by the corresponding packet transmit/receive port 24, and identifies a destination of the packet. If the destination is another device, the controller 25 identifies the network interface module 21 of the destination, and the corresponding packet transmit/receive port 24 of the destination, and transfers the packet to the switching module 22. On the other hand, if the destination of the packet is the subject device, the controller 25 identifies the control module 23 as the destination of the packet, and transfers the packet to the switching module 22. The memory 26 functions as a buffer that temporarily stores the packet transmitted and received through the packet transmit/receive port 24.

Upon receiving the packets, the switching module 22a transfers each of the packets to the network interface module 21 or the control module 23 according to a command instructed by the controller 25 as described above.

The control module 23a includes a memory 26c and a CPU 27a. The memory 26c stores a program of a software processing unit 28a, and the CPU 27a executes the program of the memory 26c to function as the software processing unit 28a.

The software processing unit 28a includes functional sites of a packet transmit/receive unit 29a, a statistical processing unit 31, and an operation management unit 34a, and data of configuration information 32 and state information 33. The packet transmit/receive unit 29a governs reception of the packets addressed to the subject device, and transmission of the packets produced in the software processing unit 28a and addressed to the other devices. The statistical processing unit 31 takes the statistic of various numeric values within the IP device 20. For example, the statistical processing unit 31 observes the number of packets (traffic) of the combination of an arbitrary source and an arbitrary destination, and records the number of packets in the state information 33. Timing of recording the number of packets in the state information 33 is, for example, given time intervals, or when receiving a request from the external. The operation management unit 34a conducts various setting on the IP device 20 on the basis of the setting request transmitted from the network management control device 50. The set contents are described in the configuration information 32. The setting request includes, for example, information on which identifier is to be allocated to the packet of the combination of the arbitrary source with the arbitrary destination when transmitting the packet from the IP device 20 to the TP device 40. Also, the operation management unit 34a acquires various pieces of information from the state information 33 on the basis of the state information acquisition request transmitted from the network management control device 50. The operation management unit 34a returns the acquired contents to the network management control device 50. The state information acquisition request includes information of the number of packets (traffic) of the combination of the arbitrary source with the arbitrary destination.

The configuration information 32 stores various pieces of configuration information of the IP devices 20.

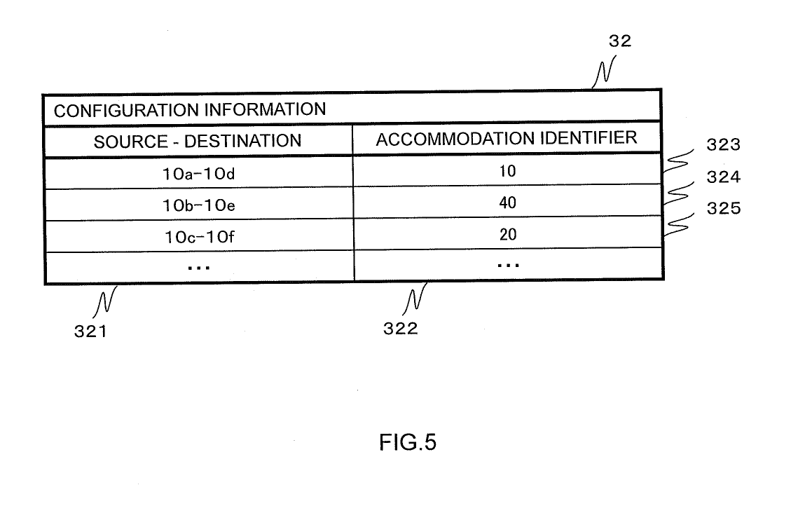

FIG. 5 is a diagram illustrating an example of the configuration information 32. The configuration information 32 includes a combination 321 of the source and the destination, and information (hereinafter referred to as “accommodation identifier”) 322 that is allocated to the packet of the combination. For example, as illustrated in FIG. 5, on a line 323 of the figure, the accommodation identifier “10” is allocated to a packet in which the combination of a source and a destination is a hub “10a-10d”, and the packet is transmitted from the IP device 20 to the TP device 40. As the accommodation identifier, for example, a VLAN ID or an IP address can be used.

The state information 33 stores various pieces of state information of the IP device 20.

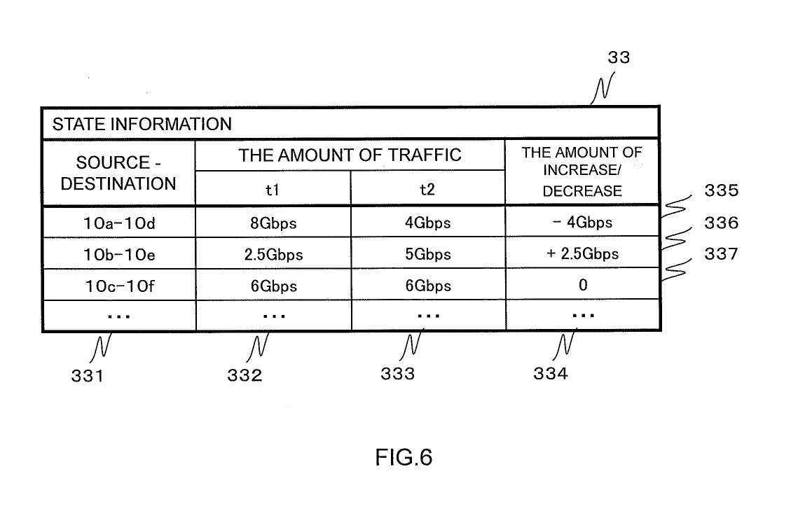

FIG. 6 is a diagram illustrating an example of the state information 33. The state information 33 includes a combination 331 of the source and the destination, a traffic volume 332 at an arbitrary time (t1), a traffic volume 333 at a time (t2) when a given time elapses from t1, and the amount of increase/decrease 334 of traffic between t1 and t2. For example, on a line 335 illustrated in FIG. 6, the number of packets (traffic) in which the combination of the source and the destination is a hub “10a-10d” is decreased from “8 Gbps” to “4 Gbps” after a given time interval by “4 Gbps”.

### (A3) Configuration of Packet Transport Device

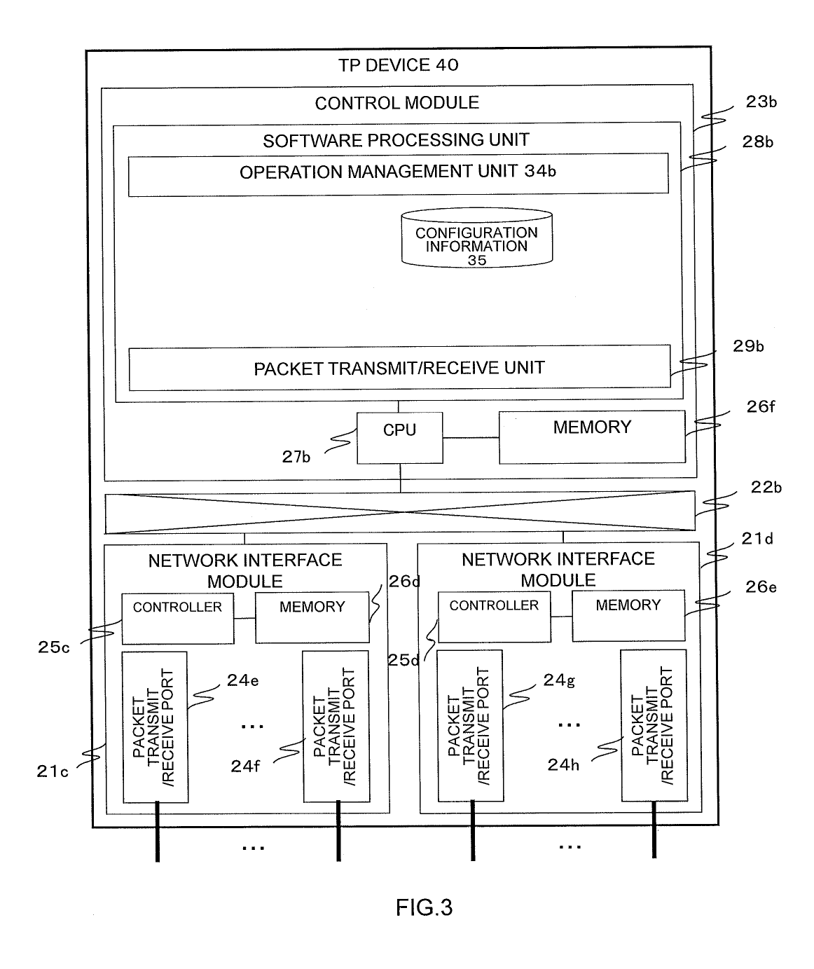

FIG. 3 is a block diagram illustrating a schematic configuration of the packet transport devices (hereinafter referred to as “TP devices”) 40. Each of the TP devices 40 includes plural network interface modules 21c, 21d, a switching module 22b, and a control module 23b.

The network interface modules 21 include plural packet transmit/receive ports 24e to 24h, controllers 25c, 25d, and memories 26d, 26e. The packet transmit/receive ports 24e to 24h are physically connected with an Ethernet (registered trademark) cable or an optical cable. The controller 25 of each network interface module 21 analyzes a packet received by the corresponding packet transmit/receive port 24, and identifies a destination of the packet. If the destination is another device, the controller 25 identifies the network interface module 21 of the destination, LSP or Pseudo Wire etc., and the corresponding packet transmit/receive port 24 of the destination, and transfers the packet to the switching module 22. On the other hand, if the destination of the packet is the subject device, the controller 25 identifies the control module 23 as the destination of the packet, and transfers the packet to the switching module 22. The memory 26 functions as a buffer that temporarily stores the packet transmitted and received through the packet transmit/receive port 24.

Upon receiving the packets, the switching module 22b transfers each of the packets to the network interface module 21 or the control module 23 according to a command instructed by the controller 25 as described above.

The control module 23b includes a memory 26f and a CPU 27b. The memory 26f stores a program of a software processing unit 28b, and the CPU 27b executes the program of the memory 26f to function as the software processing unit 28b.

The software processing unit 28b includes functional sites of a packet transmit/receive unit 29b and an operation management unit 34b, and data of configuration information 35. The packet transmit/receive unit 29b governs reception of the packets addressed to the subject device, and transmission of the packets produced in the software processing unit 28b and addressed to the other devices. The operation management unit 34b conducts various setting on the TP device 40 on the basis of the setting request transmitted from the network management control device 50. The set contents are described in the configuration information 35. The setting request includes, for example, a destination of the LSP, a bandwidth and information to be allocated to the packet which is transmitted onto the LSP etc.

Configuration information 35 stores various pieces of configuration information on the TP devices 40.

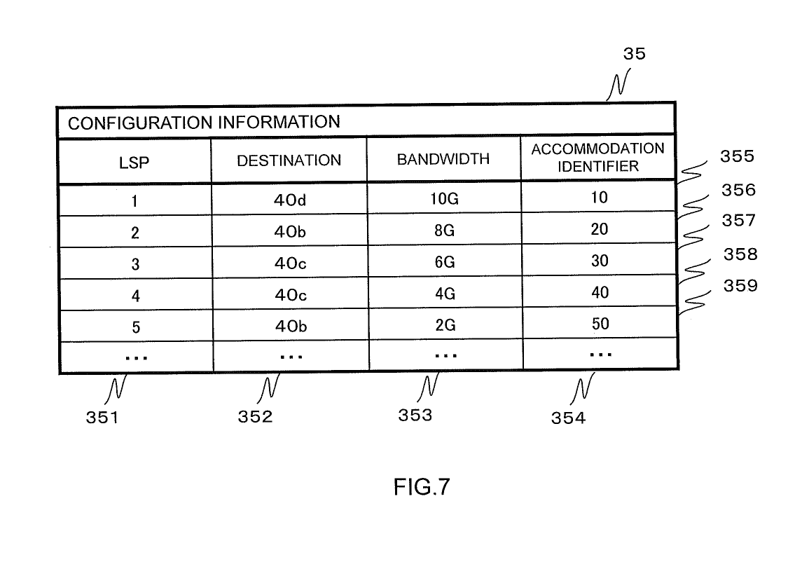

FIG. 7 is a diagram illustrating an example of configuration information 35. The configuration information 35 includes an identifier 351 of the LSP, a destination 352 of the LSP, a bandwidth 353 of the LSP, and information (hereinafter referred to as “accommodation identifier”) 354 to be allocated to the packet which is transmitted onto the LSP. For example, as illustrated in FIG. 7, on a line 355 in the figure, a packet in which a destination of the LSP “1” in the TP device 40a is directly the TP device “40d”, and its bandwidth is “10 Gbps”, and the accommodation identifier “10” is allocated to the LSP is transmitted. As an example, a case of using the “bandwidth” will be described. However, the configuration information is not limited to this example, but can use appropriate attribute information.

### (A4) Configuration of Network Management Control Device

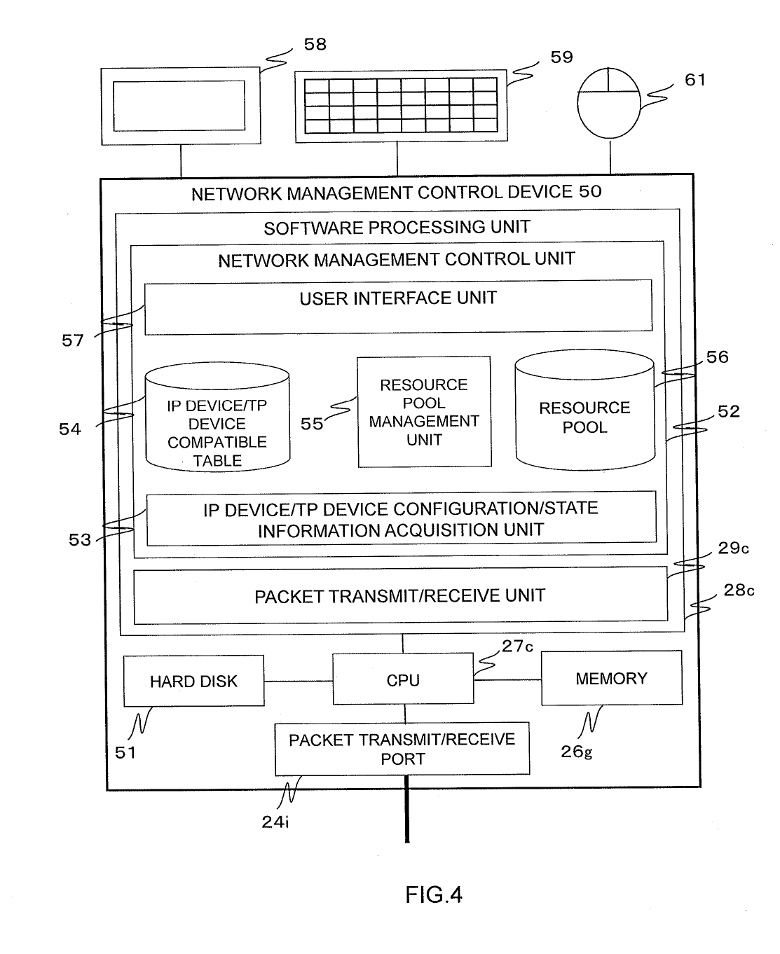

FIG. 4 is a block diagram illustrating a schematic configuration of the network management control device 50. The network management control device 50 includes a packet transmit/receive port 24i, a hard disk 51, a memory 26g, and a CPU 27c. A program of a software processing unit 28c is stored in the hard disk 51. The CPU 27c executes a program of the software processing unit 28c, and functions as a packet transmit/receive unit 29c or a network management control unit 52.

A packet transmit/receive unit 29c governs transmission or reception of the packets through the packet transmit/receive port 24i.

The network management control unit 52 is an application for managing the IP devices 20 or the TP devices 40, and includes the function sites of an IP device/TP device configuration/state information acquisition unit 53, a resource pool management unit 55, and a user interface unit 57, and data of an IP device/TP device compatible table 54 and a resource pool 56.

The IP device/TP device configuration/state information acquisition unit 53 prepares a setting request/state information acquisition request message according to a request of the resource pool management unit 55, transmits the message to the IP devices 20 or the TP devices 40, and also receives a response to the setting request from the IP devices 20 or the TP devices 40, and acquires the state information. The contents of the setting request message include, for example, information on which identifier is to be allocated to the packet of the combination of the arbitrary source with the arbitrary destination when transmitting the packet from the IP device 20 to the TP device 40 by the IP devices 20. The contents of the state information acquisition request message include, for example, the number of packets (traffic) of the combination of the arbitrary source with the arbitrary destination in the IP devices 20.

The IP device/TP device compatible table 54 stores a connection relationship between the IP devices 20 and the TP devices 40.

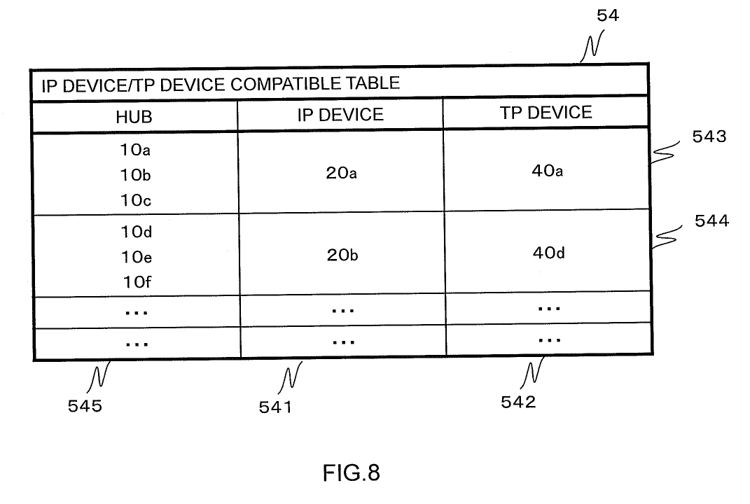

FIG. 8 is a diagram illustrating an example of the IP device/TP device compatible table 54. The IP device/TP device compatible table 54 includes an identifier 545 of a hub 10, an identifier 541 of the IP device 20 connected with the hub 10, and an identifier 542 of the TP device connected with the IP device 20. For example, as illustrated in FIG. 8, on a line 543 of the figure, the IP device “20a” is connected to the TP device “40a”.

The resource pool management unit 55 stores the obtained results into the resource pool 56 through the IP device/TP device configuration/state information acquisition unit 53. The resource pool 56 stores the configuration information on all of the IP devices 20 and the TP devices 40 to be managed by the network management control device 50.

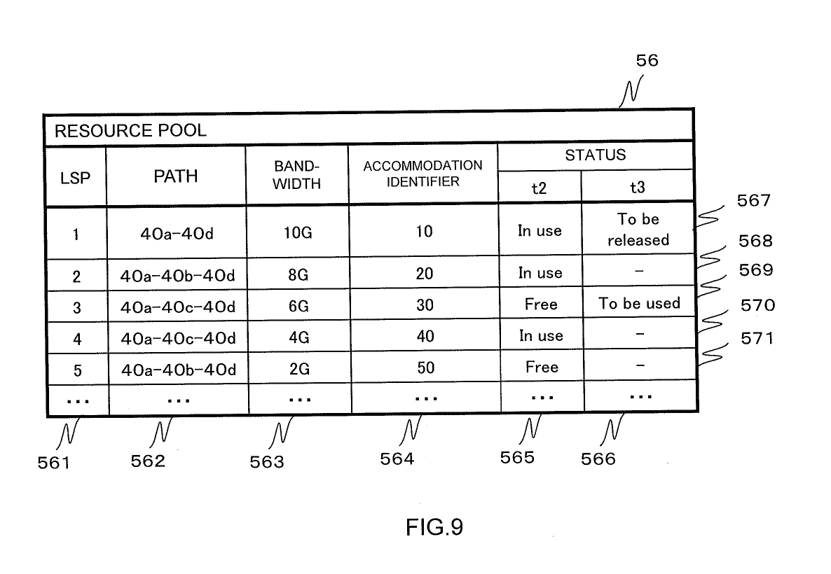

FIG. 9 is a diagram illustrating an example of the resource pool 56. The resource pool 56 includes an identifier 561 of the LSP, a path 562 of the LSP, a bandwidth 563 of the LSP, information (accommodation identifier) 564 to be allocated to the packet which is transmitted onto the LSP, a status 565 at an arbitrary time (t2), and a status 566 at a time (t3) when a given time elapses from t2. The resource pool management unit 55 can store paths 562 of the LSP and bandwidths 563 of the LSP, for example, for all of the IP devices 20 and the TP devices 40 to be managed by the network management control device 50 in advance. Also, the resource pool management unit 55 can set the identifiers 561 of the LSP, for example, in ascending order, for each data, and appropriately set and store the accommodation identifier 564. The statuses 565 and 566 are, for example, information rewritten by checking information on the resource pool 56 against information on the state information 33 of the IP devices 20, and calculating the allocation of the LSP by the resource pool management unit 55.

For example, as illustrated in FIG. 9, on a line 567 in the figure, an LSP “1” is set between the TP devices “40a” and “40d”, and its bandwidth is “10 Gbps”, and a packet allocated with the accommodation identifier “10” is transmitted to the LSP. The status is “in use” at present (t2), but is scheduled to “free” in the future (t3).

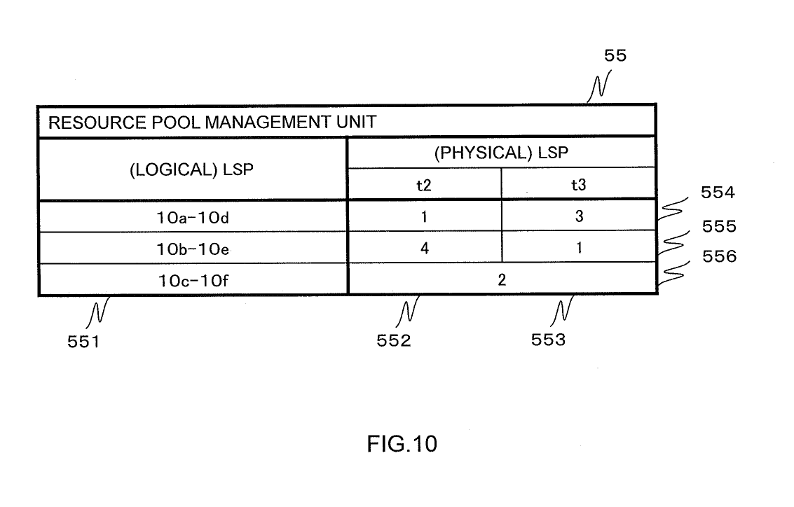

FIG. 10 is an example illustrating the result of the calculation. The result of the allocation calculation of the LSP includes an identifier 551 of a logical LSP, and an identifier (identifier 552 at an arbitrary time (t2), and an identifier 553 after a given time elapses (t3)) of a physical LSP. For example, as illustrated in FIG. 10, on a line 554 of the figure, as a result of the allocation calculation of the LSP, the logical LSP “10a-10d) uses the LSP “1” at present (t2), and uses the LSP “3” in the future (t3). The network management control device 50 thus changes the allocation of the LSP, and can use the network built by the MPLS-TP device with high efficiency. A process of the allocation calculation of the LSP will be described later.

The user interface unit 57 displays a graphical user interface (GUI) for managing the IP devices 20 and the TP devices 40 on a display device 58. Also, a network manager operates a keyboard 59 or a mouse 61 to accept various instructions.

### (A5) Procedure of Using Packet Transport Network With High Efficiency

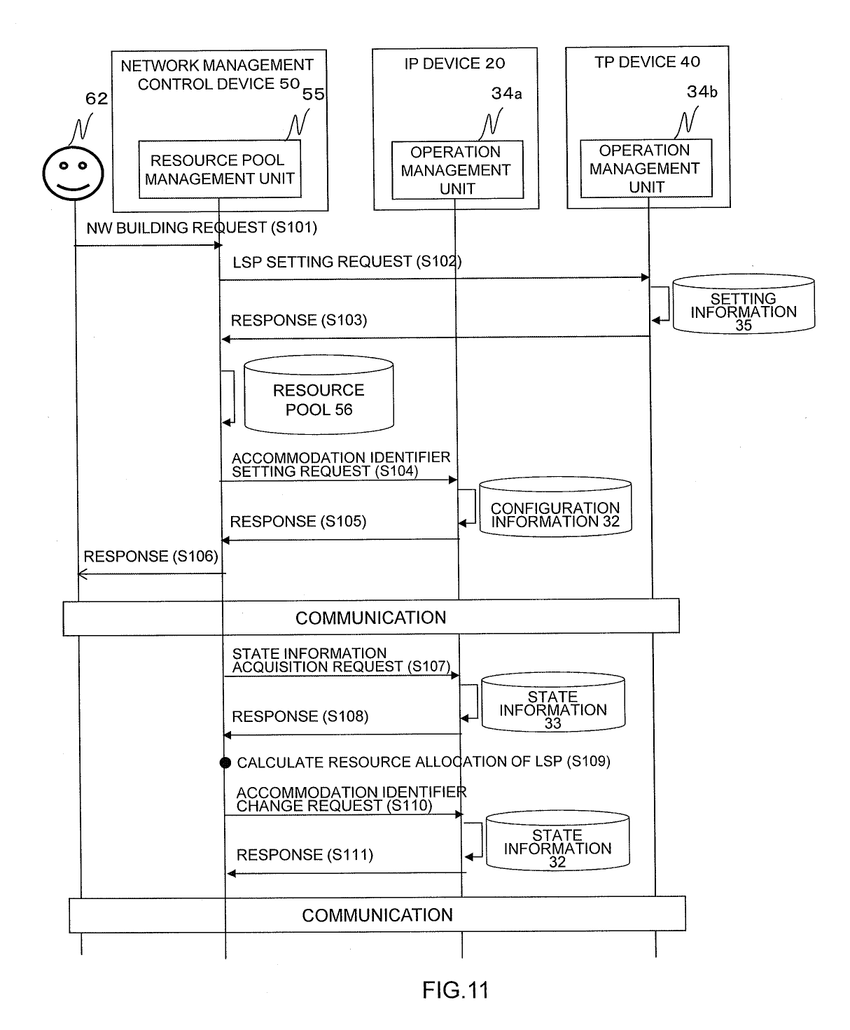

FIG. 11 is a sequence diagram illustrating a flow of processing in which the network management control device 50 optimizes a network built by the TP device quickly and flexibly, and uses the network with high efficiency.

The resource pool management unit 55 of the network management control device 50 accepts a request from a user 62 (Step S101). The request from the user 62 includes, for example, a request for building a network from an arbitrary source to a destination, and a request for guaranteeing the bandwidth over the network. The user 62 can transmit this request to the network management control device 50 by an appropriate communication means through the network 60 or another network, or directly.

In this case, as an example, it is assumed that a request from the user 62 provides the network that guarantees the bandwidth of the “10 Gbps” to the packet of the destination “10d” from the source “10a”.

The resource pool management unit 55 prepares a setting request of the LSP according to a request from the user 62, and issues the setting request of the LSP toward the TP devices 40 (Step S102). The setting request of the LSP includes, for example, an identifier of the LSP, a destination (TP device) of the LSP, the bandwidth, and information (accommodation identifier) to be allocated to the packet to be transmitted to the LSP.

Hereinafter, the above example in Step S102 will be described.

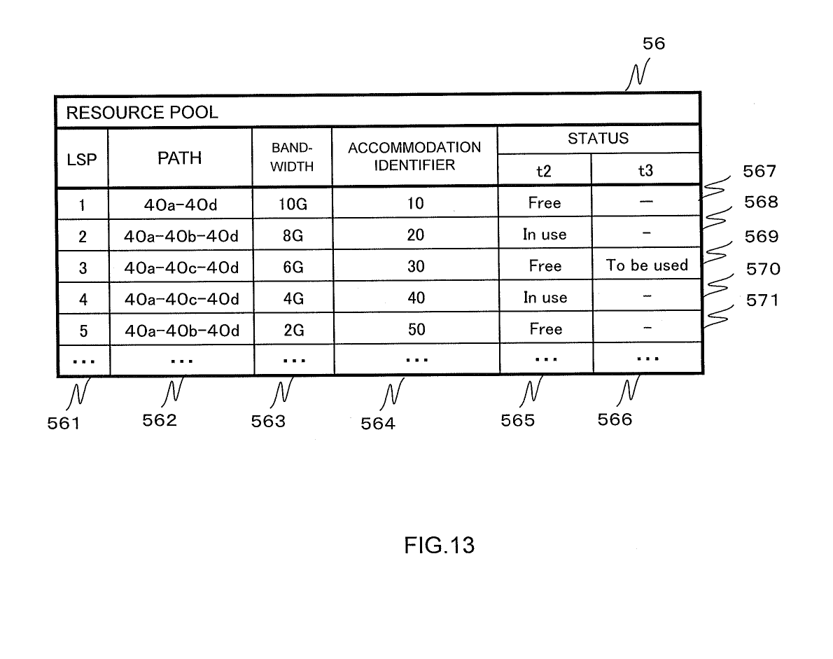

FIG. 13 illustrates an illustrative view of the resource pool 56. First, the resource pool is set as illustrated in FIG. 13 in advance.

In Step S102, the resource pool management unit 55 of the network management control device 50 identifies whether a transferable LSP which is “free” at 10 Gbps between the source “10a” and the destination “10d” is present, or not, on the basis of information on the resource pool 56. First, the resource pool management unit 55 identifies the TP devices “40a” and “40d” which are connected to the source “10a” and the destination “10d” on the basis of information on the IP device/TP device compatible table 54. Referring to FIG. 13, a resource pool that can accommodate the required bandwidth is an LSP “1” where the path is from the TP device “40a” to the TP device “40d”, and the band width is “10 Gbps”. The accommodation identifier is “10”, and the resource pool management unit 55 of the network management control device 50 recognizes that the accommodation identifier “10” needs to be allocated to the packet in which the combination of the source and the destination is “10a-10d”, and transferred from the IP devices 20 to the TP devices 40. The resource pool management unit 55 prepares the setting request for the LSP with the inclusion of the LSP identifier “1”, the destination “40d”, the bandwidth “10 G”, and the accommodation identifier “10”, and transmits the setting request for the LSP to the source TP device “40a”.

In order to be compatible with the bidirectional communication, the resource pool management unit 55 may prepares the setting request for the LSP with the inclusion of the LSP identifier “1”, the destination “40a”, the bandwidth “10 G”, and the accommodation identifier “10”, and transmit the setting request for the LSP to the source TP device “40d”.

Upon receiving the setting request for the LSP, the TP device “40a” describes the information in the configuration information 35 as illustrated in FIG. 7 according to the request, and returns a response (ok or ng, ack or nak, etc.) to the network management control device 50 (Step S103).

Then, the resource pool management unit 55 of the network management control device 50 issues the setting request for the accommodation identifier toward the IP devices 20 according to the request from the user 62 (Step S104).

In Step S104, the resource pool management unit 55 of the network management control device 50 identifies the IP devices 20 connected to the TP devices “40a” and “40d” in correspondence with the source “10a” and the destination “10d” on the basis of the IP device/TP device compatible table 54. The IP devices “20a” and “20b” are connected to the TP devices “40a” and “40d”, respectively. Hence, the resource pool management unit 55 of the network management control device 50 prepares the accommodation identifier setting request to the IP devices “20a” and “20b” so that the packet in which the combination of the source and the destination is “10a-10d” is allocated with the accommodation identifier “10”, and transferred to the TP devices 40. Then, the resource pool management unit 55 transmits the accommodation identifier setting request with the inclusion of the combination “10a-10d” of the source and the destination, and the accommodation identifier “10” to the IP devices “20a” and “20b”.

The IP devices 20 describe the results in the configuration information 32 on the basis of the accommodation identifier setting request as illustrated in FIG. 5 (data 323 in this example), and returns a response (ok or ng, ack or nak, etc.) to the network management control device 50 (Step S105).

In Step S105, upon receiving the response, as illustrated in FIG. 9, the resource pool management unit 55 sets the status to “in-use”, and stores the status in the resource pool 56 for the identifier, the path, the bandwidth, and the accommodation identifier of the LSP allocated in Step S102.

Then, the network management control device 50 responds a fact that the building of the network that satisfies the request from the user 62 is completed to the user 62 (Step S106).

With the above processing, when the packet in which the combination of the source and the destination is “10a-10d” is allocated with the accommodation identifier “10” in the IP devices 20, and transferred to the TP devices 40, the packet is transferred to the LSP “1” by the accommodation identifier “10” according to the configuration information 35 to establish the communication.

Thereafter, the resource pool management unit 55 of the network management control device 50 periodically issues the state information acquisition request toward the IP device 20 (Step S107). The state information acquisition request can include the source—the destination (in this example, “10a-10d”) which are in communication. The IP device 20 returns the result to the network management control device 50 with reference to the state information 33 on the basis of the request (Step S108). In this example, the IP device 20 obtains the amount of increase/decrease as a reference result, and returns a response including the source—the destination “10a-10d” and the amount of increase/decrease “−4 Gbps”. In this case, as an example of the trend of the packets, the amount of increase/decrease of the bandwidth will be described. However, without being limited to this configuration, an index representing an appropriate trend can be used.

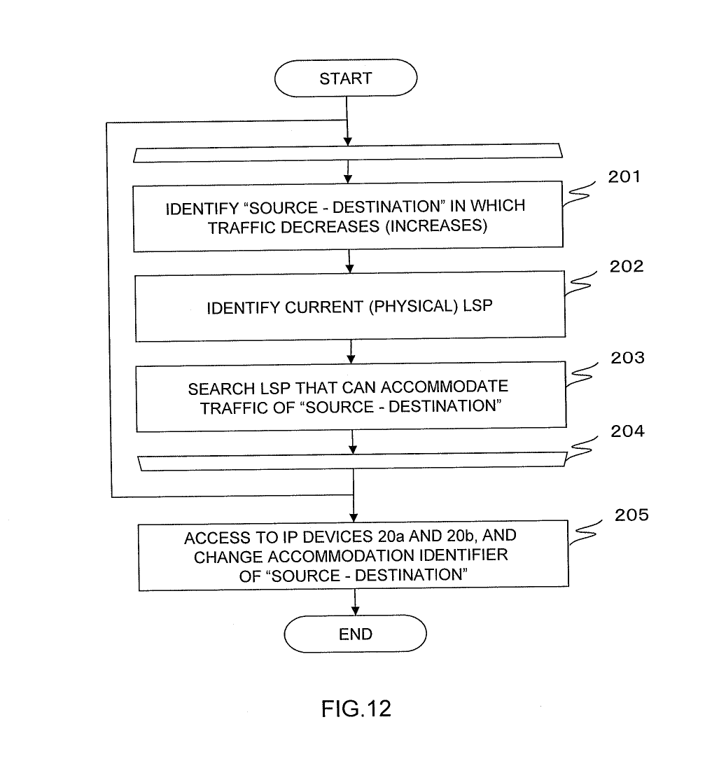

Subsequently, the resource pool management unit 55 of the network management control device 50 checks the information on the resource pool 56 against the information on the state information 33 acquired in the above processing, and calculates the allocation of the LSP as illustrated in a flowchart of FIG. 12 (Step S109).

FIG. 12 is a flowchart illustrating an example of processing of allocation calculation of the LSP, which is implemented by the resource pool management unit 55 of the network management control device 50. The resource pool management unit 55 acquires the state information 33 of the respective IP devices from the response in Step S108, and identifies “source—destination” in which the number of packets (traffic) decreases (increases) (201). For example, in the case of FIG. 6, the amount of traffic decreases in the packet in which “source—destination” is “10a-10d”, and decreases from “8 Gbps” to “4 Gbps” within an arbitrary time.

Then, the resource pool management unit 55 identifies the LSP allocated to the packet identified in the above process (202). As illustrated in FIG. 10, the resource pool management unit 55 recognizes the packet in which the combination of the source and the destination is “10a-10d” is allocated with the LSP “1” at present (t2).

Subsequently, the resource pool management unit 55 identifies whether the LSP sufficient for transferring the current amount of traffic of the packet identified by the above processing is present, or not, with reference to the resource pool 56 (203). The amount of traffic of the packet in which the “source—destination” is “10a-10d” decreases to “4 Gbps”, and when the resource pool 56 is an example illustrated in FIG. 9, LSP “1”, “2”, “3”, and “4” can be candidates with reference to the resource pool 56. Among those LSP, the LSP in which the status is “free” at present (t2) is “3”. Hence, the resource pool management unit 55 determines that the packet in which the “source—destination” is “10a-10d” is allocated with the LSP “3” in which the path is from the TP device “40a” through the TP device “40c” to the TP device “40d”, and the bandwidth is “6 Gbps”. As a result, since the LSP “1” becomes “free” in the future (t3), and the LSP “3” becomes “in-use” in the future (t3), the resource pool management unit 55 rewrites the status of the resource pool 56. This LSP allocation calculation is implemented for each of “source—destination” in which the amount of traffic decreases (increases) to optimize the allocation of the LSP (204). Then, the resource pool management unit 55 manages the results of calculation as illustrated in FIG. 10. On a line 544 of the figure, the logical LSP “10a-10b” is allocated with LSP “1” at present (t2), and the LSP “3” is recorded to be allocated in the future (t3).

The amount of traffic at times t1 and t2 is used instead of the amount of increase/decrease, and the resource pool management unit 55 may calculate the increase/decrease of the amount of traffic in Step 201.

Also, in Step S107, the state information 33 on the respective IP devices 20 may be acquired without identifying the source—destination. In this case, the resource pool management unit 55 may identify the “source—destination” in which the amount of traffic increases or decreases according to the received state information 33 in Step S201.

Then, the resource pool management unit 55 realizes the result of the LSP allocation calculation by issuing a change request of the accommodation identifier to the IP device 20 (205, Step S110). For example, when the packet in which “source—destination” is “10a-10d” is allocated with the LSP “3” in the future (t3), the accommodation identifier is “30” with reference to the resource pool 56. Hence, the resource pool management unit 55 requires the IP device 20 to allocate the accommodation identifier “30” to the packet in which the combination of the source and the destination is “10a-10d”. That is, in this example, the accommodation identifier change request includes the source—destination “10a-10d”, and the accommodation identifier “30”.

The IP device 20 implements the request, describes the result in the configuration information 32, and returns a response (ok or ng, ack or nak, etc.) to the network management control device 50 (Step S111).

With the above processing, when the packet in which the combination of the source and the destination is “10a-10d” is allocated with the accommodation identifier “30” in the IP devices 20, and transferred to the TP devices 40, the packet is transferred to the LSP “3” by the accommodation identifier “30” to establish the communication.

With the above processing, the network built by the TP device can be optimized quickly and flexibly according to a request from the user who conducts the data communication or a trend of the traffic, and the network built by the TP device can be used with high efficiency.

The present invention and/or the present embodiments can be realized as the configuration including the IP devices 20, the IP devices 40 and the network management control device 50 as mentioned above, also as the network management control method or a computer program which is executed by the network management control device. The computer program may be stored in a computer readable storage medium. The storage medium can be used a various medium such as a floppy disc (Registered Trade mark), CD-ROM, DVD-ROM, a magneto optical disc, a memory card, or a hard disc etc.

The present invention and the present embodiments are not limited to the above embodiments, but include various modified examples. For example, in the above-mentioned embodiments, in order to better understand the present invention, the specific configurations are described. However, the present invention does not always provide all of the configurations described above. Also, a part of one configuration example can be replaced with another configuration example, and the configuration of one embodiment can be added with the configuration of another embodiment. Also, in a part of the configuration of one embodiment, another configuration can be added, deleted, or replaced.

Also, about the above-described respective configurations, functions, and processors etc., examples to produce or execute a program which realizes parts or all of them was explained. However parts or all of them may be realized, for example, as an integrated circuit, or other hardware.

What is claimed is:

1. A network management control device in a network management control system including plural packet transfer devices and plural packet transport devices, and having plural paths between the packet transport devices in which each of the packet transfer devices transmits a packet including an identifier necessary for transferring to the paths, and each of the packet transport devices transfers the packet to the paths according to the identifier,
wherein the network management control device manages the plurality of packet transfer devices and the plurality of packet transport devices,
the network management control device identifies a path that guarantees a bandwidth for transmitting the packet, and the identifier for the path, on the basis of a request including a bandwidth from a user who transmits the packet, and
the network management control device sets the packet transfer devices so as to allocate the identifier to the packet from the user and transmit the packet to the packet transport device.

2. The network management control device according to claim 1, comprising:
a resource pool including a path identifier, a path, a bandwidth, an identifier, and a status indicative of availability; and
a correspondence table representing a connection relationship of a user device, the packet transfer devices, and the packet transport devices,
wherein upon receiving a request including a source, a destination, and a bandwidth of the user device from a user, the network management control device obtains a source packet transport device connected to the source, and a destination packet transport device connected to the destination with reference to the correspondence table, transmits a path setting request including an appropriate path that guarantees the bandwidth, a path identifier, a destination packet transport device, the bandwidth, and the identifier to the source packet transport device with reference to the resource pool, and allows the source packet transport device to store information included in the path setting request,
the network management control device obtains a source packet transfer device connected to the source with reference to the correspondence table, transmits an identifier setting request including the source, the destination, and the identifier to the source packet transfer devices, and allows the source packet transfer device to set information included in the identifier setting request, and
the network management control device stores a status indicating in-use in the resource pool in correspondence with the path identifier or the path.

3. The network management control device according to claim 2, wherein the network management control device transmits the path setting request also to the destination packet transport device in order to be compatible with a bidirectional communication, and sets information.

4. The network management control device according to claim 2, wherein the network management control device transmits an accommodation identifier setting request also to the source packet transfer device in order to be compatible with a bidirectional communication, and sets information.

5. The network management control device according to claim 1, wherein the network management control device acquires a trend of the packet from the packet transfer devices,
the network management control device identifies a path that guarantees a bandwidth for transmitting the packet, and an identifier for the path according to the trend of the packet, and
the network management control device sets the packet transfer devices so as to allocate the identifier to the packet, and transmit the packet to the packet transport device.

6. The network management control device according to claim 5, wherein the network management control device transmits a state information acquisition request to the packet transfer device periodically or at predetermined timing,
the network management control device receives a response including a traffic volume or the amount of increase/decrease in the traffic volume for the source and the destination from the packet transfer devices,
the network management control device obtains a path identifier, a path, and an identifier that enable a new bandwidth corresponding to the traffic volume or the amount of increase/decrease to be transferred to the source and the destination with reference to the resource pool, and
the network management control device transmits an identifier change request including the source, the destination, and the identifier to the packet transfer device, and allows the packet transfer device to change the identifier for the source and the destination according to the identifier change request.

7. The network management control device according to claim 6, wherein the state information acquisition request identifies a source and a destination, and acquires state information on the source packet transport device.

8. The network management control device according to claim 1, wherein the path is a label switched path (LSP) or a pseudo wire.

9. The network management control device according to claim 8, wherein the identifier is a VLAN ID or an IP address.

10. The network management control device according to claim 5, wherein the path is a label switched path (LSP) or a pseudo wire.

11. The network management control device according to claim 10, wherein the identifier is a VLAN ID or an IP address.

12. The network management control device according to claim 5,
wherein the network management control device calculates a path suitable for transmitting the packet on the basis of a bandwidth of the path according to the traffic volume of the packets, or the amount of increase/decrease of the traffic volume.

13. A network management control system including:
plural packet transfer devices;
plural packet transport devices; and
a network management control device,
wherein the network management control system has plural paths between the packet transport devices, each of the packet transfer devices transmits a packet including an identifier necessary for transferring to the paths, and each of the packet transport devices transfers the packet to the paths according to the identifier, and
wherein the network management control device manages the plurality of packet transfer devices and the plurality of packet transport devices,
the network management control device identifies a path that guarantees a bandwidth for transmitting the packet, and the identifier for the path, on the basis of a request including a bandwidth from a user who transmits the packet, and
the network management control device sets the packet transfer devices so as to allocate the identifier to the packet from the user and transmit the packet to the packet transport device.

14. The network management control system according to claim 13,
wherein each of the packet transfer devices holds first configuration information including an identifier for the source and the destination, and
obtains the identifier according to the source and the destination of the received packet with reference to the first configuration information, allocates the identifier to the received packet, and transmits the received packet to the packet transport device, and
each of the packet transport devices holds second configuration information including a path identifier, a destination packet transport device, a bandwidth, and an identifier, and
transfers the packet according to a path identifier and/or a destination packet transport device according to the identifier included in the received packet with reference to the second configuration information.

15. A network management control method in a network management control system including plural packet transfer devices and plural packet transport devices, and having plural paths between the packet transport devices in which each of the packet transfer devices transmits a packet including an identifier necessary for transferring to the paths, and each of the packet transport devices transfers the packet to the paths according to the identifier, the network management control method including:
managing the plurality of packet transfer devices and the plurality of packet transport devices,
identifying a path that guarantees a bandwidth for transmitting the packet, and the identifier for the path, on the basis of a request including a bandwidth from a user who transmits the packet, and
setting the packet transfer devices so as to allocate the identifier to the packet from the user and transmit the packet to the packet transport device.
